(19) United States
(12) Patent Application Publication
(10) Pub. No.: US 2023/0412236 A1
(43) Pub. Date: Dec. 21, 2023

(54) Proactive Link Blockage Avoidance for Reliable mmWave Communication

(71) Applicant: Telefonaktiebolaget LM Ericsson (publ), Stockholm (SE)

(72) Inventors: Ashkan Kalantari, Malmö (SE); Bipin Balakrishnan, Kävlinge (SE)

(21) Appl. No.: 18/032,746

(22) PCT Filed: Oct. 22, 2020
(86) PCT No.: PCT/EP2020/079682

§ 371 Date: Apr. 19, 2023

(51) Int. Cl. H04B 7/06; H04B 7/08

(52) U.S. Cl. CPC H04B 7/06952; H04B 7/088

(57) ABSTRACT

Blockage of a mmWave communication link, due to movement of one or both of the wireless devices, and/or movement of an obstacle, is predicted. An environment is monitored by imaging devices, which may be fixed or mobile, and may be on the wireless devices. Objects in the environment are detected and their motion tracked from the image data. Based on the motion of the wireless device(s) and/or an obstacle, a link blockage event—whereby an obstacle interrupts communications on the link—is predicted, and a start time is estimated. Prior to the start time, directional antenna beams of both wireless devices are directed to a passive reflector, and the mmWave communication link is routed around the obstacle. Passive reflectors may be deployed through the environment. They may be moveable in angle and tilt to assist in avoiding link blockage. Beam re-training is performed on a group of directional antenna beam pairs directed towards the passive reflector. The directional antenna beam pairs are ranked by a channel quality metric, such as SINR, and a pair is chosen for use during the blockage (two pairs for duplex links). A different frequency may be used for the blockage avoidance communication link, reducing interference and allowing the same passive reflector to be used by more than one wireless communication link. The wireless communication link is transferred to the re-trained direction antenna beams, directed to a passive reflector, prior to the start of the link blockage event. For the duration of blockage, the wireless devices communicate via the passive reflector, without loss or interruption, which is critical in URLLC use cases.

### TECHNICAL FIELD

The present invention relates generally to wireless communication, and in particular to systems and methods for avoiding link blockage in mmWave communications in dynamic environments.

### BACKGROUND

Wireless communication systems continue to evolve in technical sophistication, offering ever higher data rates and bandwidth, and lower latency and power consumption. This evolution supports new content types, such as high-definition streaming video, real-time gaming, and the like to conventional wireless devices, such as smartphone, as well as new types of devices designed to exploit the expanded capabilities, such as virtual reality headwear.

In addition to expanding the capabilities of broadband communications, new wireless communication systems also support Machine-Type Communications (MTC, also known as Machine-to-Machine or M2M, and also known as the Internet of Things, or IoT). This class of wireless devices contemplates potentially massive numbers of wireless communication devices, generally embedded in other products, and performing tasks such as environmental monitoring, meter-reading, process control, robotics, automated manufacturing, autonomous vehicle control, and the like. To meet the stringent reliability and latency requirements of some of these use cases, 3GPP (the industry consortium that develops technical standards for wireless networks) has developed features to support the Ultra-Reliable Low-Latency Communication (URLLC) use case.

To implement both the expanded broadband and MTC evolutions, future wireless communication networks look to expanded spectrum, for example by exploiting the millimeter wave (mmWave) spectrum. The mmWave spectrum generally refers to Radio Frequency (RF) electromagnetic waves having wavelengths between 10 and 1 millimeters, which corresponds to GHz— also known as the Extremely High Frequency (EHF) band. These frequencies offer both advantages and disadvantages to wireless communications. Some of these are discussed by Rangan, et al., in “Millimeter-Wave Cellular Wireless Networks: Potentials and Challenges,” published in the Proceedings of the IEEE, Vol. 102, No. 3, March 2014.

The EHF carriers support very high bit rates and complex modulation. Also, due to the short wavelength, antenna elements are very small. This allows the integration of a large number of antenna elements into a linear or planar antenna array, which is still small enough to incorporate into products such as smartphones. By selectively controlling the phase of signals transmitted or received by each antenna element in an array, the constructive and destructive interference of RF signals from or to the elements can be controlled to create one or more very compact, highly directional antenna beams, each of which can be electronically steered to a desired azimuth and elevation. A transmit directional antenna beam concentrates RF energy of its transmitted signal in a controlled direction. A receive directional antenna beam increases the sensitivity of the receiver in a controlled direction. As used herein, a “directional antenna beam” may refer to a transmit or receive directional antenna beam. A wireless device can “point” these highly directional beams directly at another wireless device, creating a communication link with almost all transmitter power focused on the intended target, and the receiver sensitivity focused on the intended signal source, maximizing channel quality between the two. As compared to omni-directional antennas, directional antenna beams result in more secure communication links, lower interference between different links, and lower wasted power (an important consideration for battery-powered devices).

On the other hand, mmWave communication links suffer atmospheric attenuation, which is exacerbated by humidity and rain. Additionally, while tightly focused, directional beams have the advantages discussed above, they do not benefit from multi-path propagation. In omni-directional transmissions, a signal may reach a receiver by a variety of different paths, such as being reflected by buildings, terrain, or the like. These disparate multi-path copies of the signal can be time-aligned by the receiver and combined, improving received signal strength and the Signal to Interference and Noise Ratio (SINR). Because mmWave communications use highly directional antenna beams, they are subject to link failure if a clear line-of-sight (LOS) alignment is not maintained between wireless devices. Also, a moving wireless device must constantly adjust its transmit and receive beam alignment, to keep the beams “aimed” at the communication link's partner device. A further complication in many dynamic environments is that another moving object may physically block the communication link, if it moves between the two wireless devices, or one or both of the devices move such that a moving or stationary object becomes an obstacle. This is referred to herein as “link blockage.”

One known solution to non-line-of-sight (NLOS) mmWave communications is the use of one or more passive reflectors to route transmit and receive directional beams around obstacles. As used herein, a “passive reflector” refers to a device or surface that reflects incident mmWave RF energy without significant loss of power. A passive reflector is distinguished from a relay or repeater, which contains an active transceiver to receive a signal and re-transmit it. While a passive reflector may include some receiver electronics, e.g., to measure signal strengths or the like, it diverts the path of mmWave directional beams by physical reflection, not reception and retransmission.

As one example, U.S. Patent Application Publication No. 2010/0119234 to Suematsu, et al. discloses the use of one or more passive reflectors, e.g., a metal plate, metal sheet, or metal film, to route a mmWave communication link around an obstacle such as a television or low wall. As another example, U.S. Pat. No. 8,7978,211 to Valdes-Garcia discloses a combination of a passive reflector, and Tx and Rx units tilting their transmit and receive directional beams, to establish a NLOS path for a mmWave communication link that routes the link around an obstacle. Peng, et al., in “An Effective Coverage Scheme With Passive-Reflectors for Urban Millimeter-Wave Communication,” published in IEEE Antennas and Wireless Propagation Letters, Vol, 15, 2016, study the design parameters fora spherical cap passive reflector having high conductivity, and conclude that a plurality of such passive reflectors remarkably increase the coverage radius of an urban mmWave cell. The results of similar work are published by Zhou, et al. in “Mirror Mirror on the Ceiling: Flexible Wireless Links for Data Centers,” SIGCOMM'12 Aug. 13-17, 2012, Helsinki, Finland, and in International Patent Application Publication WO 2007/136290 to Alamouti, et al. Field measurements, showing a higher link gain when using a passive reflector in mmWave communications, are documented by Khawaja, et al. in “Coverage Enhancement for mmWave Communications using Passive Reflectors,” published in the 2018 11th Global Symposium on Millimeter Waves (GSMM), Boulder, CO, USA, 2018; Khawaja, et al. in “Effect of Passive Reflectors for Enhancing Coverage of 28 GHz mmWave Systems in an Outdoor Setting,” published in the IEEE Radio and Wireless Symposium (RWS), 2018; and Hiranandani, et al. in “Effect of Passive Reflectors on the Coverage of IEEE 802.11ad mmWave Systems,” published in 2018 IEEE 88^{th} Vehicular Technology Conference (VTC-Fall), 2018. U.S. Pat. No. 10,469,619 to Shimizu, et al. discloses dynamic use of NLOS beam alignment for vehicle communications.

Another approach to NLOS mmWave communication links is the use of beam training and beam selection algorithms to maneuver around blockages. As used herein, beam “training” (or “re-training”) has the ordinary meaning of these terms to one of skill in the wireless communication arts. Generally, and without limitation, beam training refers to a process of successive channel evaluation (e.g., using reference signals) using different directional antenna beam pairs, and selecting the pair yielding highest channel quality for the wireless devices' current positions, orientations, and propagation conditions. As used herein, a directional antenna beam “pair” refers to a transmit directional antenna beam at one wireless device, and a corresponding receive directional antenna beam at the other wireless device. For duplex communication links, the training/re-training process is performed in both directions, such that at any given time, two directional beam pairs are active on the link.

See, for example, Lim, et al., “Efficient Beam Training and Channel Estimation for Millimeter Wave Communications Under Mobility,” published in IEEE Trans. Wireless Commun., 2018, for further discussion of beam training for mmWave communication links. An, et al., in “Beam switching support to resolve link-blockage problem in 60 GHz WPANs,” published in 2009 IEEE 20th International Symposium on Personal, Indoor and Mobile Radio Communications, use beam switching from a LOS link to a NLOS link to avoid blockage by a moving person in a typical indoor WPAN scenario. This problem is addressed by Gao, et al., in “Double-Link Beam Tracking Against Human Blockage and Device Mobility for 60-GHz WLAN,” published in IEEE WCNC'14 Track 1 (PY and Fundamentals) by a double-link beam tracking scheme, in which an alternative link is tracked as well as a transmission link, and switching to the alternative link when a human blockage is detected in the transmission link. Beam training and link blockage handling algorithms for Single-User Multiple Input/Multiple Output (SU-MIMO) are proposed by Xue, et al. in “Beamspace SU-MIMO for Future Millimeter Wave Wireless Communications,” published in the IEEE Journal on Selected Areas in Communications, Vol. 35, No. 7, July 2017, and for multi-user MIMO by Xue, et al. in “Beam Management for Millimeter-Wave Beamspace MU-MIMO Systems,” published in IEEE Transactions on Communications, Vol. 67, No. 1, January 2019. U.S. Pat. No. 9,472,844 to Kasher discloses the use of a camera on a wireless device to track movement of the wireless device. This information is then used to change the orientation or directivity of the wireless device's directional beams to improve communication link quality. All of the prior art papers and patent literature cited above are incorporated herein by reference, in their entireties.

Hence, it is known in the prior art to utilize passive reflectors to route mmWave communication links around static obstacles, to use beam training and double-link beam tracking to maintain high mmWave communication link quality, and to use a wireless device's camera to track its movements and update directional beams accordingly. However, the prior art does not resolve the problem of dynamic link blockage, or offer solutions that avoid interruption of mmWave communication links due to predictable link blockages.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

According to embodiments of the present invention disclosed and claimed herein, blockage of a mmWave communication link, due to movement of one or both of the wireless devices, and/or movement of an obstacle, is predicted. An environment is monitored by imaging devices, such as visible light or infrared cameras, RADAR, LiDAR, or the like. The imaging devices may be fixed or mobile, and may be on the wireless devices. Object detection and classification, and motion tracking and trajectory prediction, are performed on objects in the environment, from the video or other image data. Based on the motion of one or both of the wireless devices, and/or motion of an obstacle, a link blockage event—whereby an obstacle interrupts communications on the link—is predicted, and a start time of the blockage event is estimated. Prior to the start time, directional antenna beams of both wireless devices are directed to a passive reflector, and the mmWave communication link is routed around the obstacle. Passive reflectors may be deployed throughout the environment. They may be moveable in angle and tilt to assist in avoiding link blockage. Beam re-training is performed on a group of directional antenna beam pairs directed towards the passive reflector. The directional antenna beam pairs are ranked by a channel quality metric, such as SINR, and a pair is chosen for use during the blockage (two pairs for duplex links). A different frequency may be used for the blockage avoidance communication link, reducing interference and allowing the same passive reflector to be used by more than one wireless communication link. The wireless communication link is transferred to the re-trained directional antenna beams directed to a passive reflector prior to the start of the link blockage event. For the duration of blockage, the wireless devices communicate via the passive reflector, without loss or interruption, which is critical in URLLC use cases.

One embodiment relates to a method of avoiding blockage of a wireless communication link between first and second wireless devices, each using at least one of a transmit and a receive directional antenna beam. Information about motion of one or more of the first wireless devices, the second wireless devices, and an obstacle is obtained. A blockage event, whereby the wireless communication link between the first and second wireless devices is blocked by the obstacle, is predicted. At least a start time of the blockage event is estimated. A group of directional antenna beams directed towards the passive reflector is re-trained. The wireless communication link between the first and second wireless devices is transferred to the re-trained directional antenna beams directed devices towards the passive reflector, to route the wireless communication link around the obstacle, prior to the start time of the blockage event.

Another embodiment relates to a first wireless device configured to generate a transmit or receive directional antenna for a wireless communication link with a second wireless device. The first wireless device includes communication circuitry comprising a linear or planar antenna element array, and processing circuitry operatively connected to the communication circuitry. The processing circuitry is configured to obtain information about motion of one or more of the first wireless devices, the second wireless devices, and an obstacle; predict a blockage event whereby the wireless communication link between the first and second wireless devices is blocked by the obstacle; estimate at least a start time of the blockage event; re-train a group of directional antenna beams directed towards the passive reflector; and transfer the wireless communication link between the first and second wireless devices to the re-trained directional antenna beams directed devices towards the passive reflector, to route the wireless communication link around the obstacle, prior to the start time of the blockage event.

### BRIEF DESCRIPTION OF THE DRAWINGS

The present invention will now be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

FIG. 1 is a block diagram of a representative, dynamic, monitored environment in which mmWave communications occur.

FIG. 2 is a flow diagram of a method of avoiding blockage of a wireless communication link between first and second wireless devices, each using directional antenna beams.

FIG. 3 is a schematic block diagram of a wireless device with an antenna element array generating directional antenna beams.

FIG. 4 is a functional block diagram of a wireless device.

### DETAILED DESCRIPTION

For simplicity and illustrative purposes, the present invention is described by referring mainly to an exemplary embodiment thereof. In the following description, numerous specific details are set forth in order to provide a thorough understanding of the present invention. However, it will be readily apparent to one of ordinary skill in the art that the present invention may be practiced without limitation to these specific details. In this description, well known methods and structures have not been described in detail so as not to unnecessarily obscure the present invention.

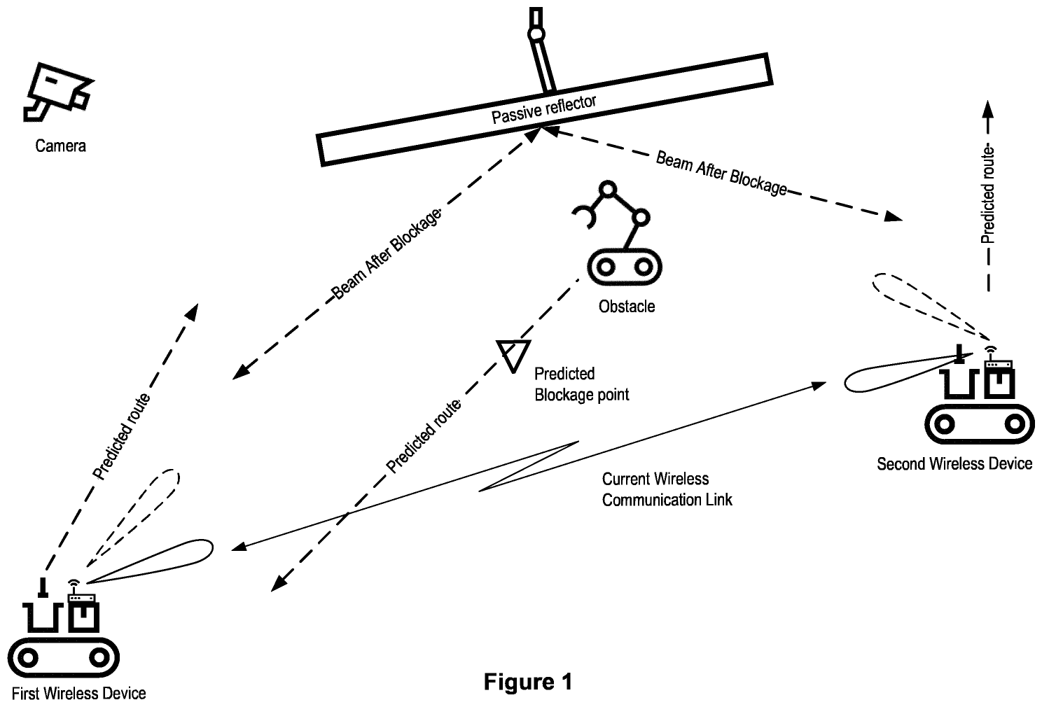

FIG. 1 depicts a representative environment, in which a mmWave communication link between two wireless devices will suffer blockage by an obstacle. The blockage event is predicted, and the mmWave communication link is re-routed around the obstacle, in advance of the blockage event, by use of a passive reflector. Accordingly, there is no interruption of communications between the wireless devices.

The communication link is blocked due to the obstacle moving to interrupt the link, one or both of the wireless devices moving so as to place the obstacle in the link path, or a combination of such motions. In any of these cases, however, by monitoring the environment, and hence the movement of the wireless devices and the obstacle(s), the blockage is predictable. According to embodiments of the present invention, the communication link blockage is not only predicted, but quantified in time. The start and end times of the blockage event, and hence its duration, are estimated based on the motion of all relevant entities. In response to the blockage event prediction—and its imminence—the mmWave communication link between two wireless devices is routed around the obstacle, via one or more passive reflectors. In one embodiment, the wireless devices tilting their current directional antenna beams toward the passive reflector. In another embodiment, when the link blockage is less imminent, the wireless devices performing beam training to select the optimal directional antenna beam pairs, prior to the blockage event start time.

The use case depicted in FIG. 1 is, e.g., within a factory, manufacturing facility, warehouse, or similar environment, although embodiments of the present invention are not limited to such environments. The environment is monitored, such as by one or more cameras. In general, the environment may be monitored by visible light cameras, infrared cameras, RADAR, LiDAR, or any combination thereof, referred to collectively herein as “imaging devices.” Because most factories and similar environments are already outfitted with security cameras, the use of visible light cameras has particular applicability to embodiments of the present invention, as it dramatically reduces cost of their implementation. Object detection and motion tracking programs, based on frame-to-frame analysis of video or other image data from any of the above imaging devices, are well known and commercially available. Based on such technology, all static and moving objects in the environment are detected and monitored. In particular, the motion of moving objects is monitored, and their near-term trajectories are predicted.

In one embodiment, the computation performing the object detection and motion tracking is performed locally, at each imaging device. In this embodiment, information about each object, such as its ID, location, speed, size, and trajectory, forms a relatively compact data set, and is transmitted to the entity performing link blockage avoidance. In one embodiment, this is a central processor, which may perform link blockage avoidance for a plurality of ongoing mmWave communication links between various wireless devices. In another embodiment, the motion information about objects is transmitted to one or both of the wireless devices, which perform their own link blockage avoidance. In either case, in one embodiment the frequency of updating the motion information about each object is adjusted based on the speed of the object. In one embodiment, the extracted features of two or more imaging devices are fused, to increase object detection and tracking accuracy. In one embodiment, one or more imaging devices may zoom and/or pan, to improve object detection accuracy.

In one embodiment, one or more imaging devices is itself mobile. For example, a camera or RADAR may be installed on a mobile wireless device engaging in a mmWave communication link. Alternatively, the imaging device may be autonomously mobile, or controlled by a central processor. In any event, it additionally includes positioning capability, such as an inertial measuring unit (IMU), receivers of fixed location beacons for triangulation, use of Time Difference of Arrival (TDOA) in a cellular network, or the like. Positioning technology is well known and commercially available. Positioning of a mobile imaging device is necessary to compensate for its own motion, to determine if an imaged object is moving, and if so its speed, direction, and the like. In one embodiment, the predicted trajectory of detected moving objects is used to select the imaging device(s) with the best view of the objects.

In FIG. 1, first and second wireless devices are mounted on autonomous vehicles, such as fork lifts, delivery carts, personnel transports, or the like, and are each mobile. Each of the first and second wireless devices includes communication circuitry including a linear or planar antenna array, and control circuitry operative to generate and steer highly directional antenna beams. In one embodiment, the elements of the antenna array are divided into multiple groups to create multiple such directional beams, each of which is independently steerable. In general, throughout this discussion, transceivers are assumed at each wireless device. However, embodiments of the present invention are fully applicable to mmWave communication links between a first wireless device that only transmits and a second wireless device that only receives.

The first and second wireless devices additionally include an IMU sensor, or other positioning technology, as discussed above. In one embodiment, one or both of the first and second wireless devices also includes one or more imaging devices, as discussed above.

FIG. 1 depicts a current mmWave communication link between the first and second wireless devices as a solid line, and corresponding directional antenna beams at each wireless device, pointing toward the other wireless device, are indicated by solid lines. This is a LOS link, with no obstruction or blockage, and concomitantly good channel quality. Alternatively, in an embodiment in which a LOS link is not possible, the mmWave communication link may be routed via one or more passive reflectors (not shown in FIG. 1 for the current link). Initially, and periodically as the wireless devices move about, beam training is performed to select an optimal directional antenna beam pair between the two.

As indicated by the dashed-line motion vectors labeled “predicted route,” each of the first and second wireless devices is in motion. The first wireless device is moving up and to the right, as depicted in FIG. 1, and the second wireless device is moving straight up the page. In one embodiment, these trajectories are predicted, such as by a central processor, based on detection and motion tracking of the wireless devices from the environment's imaging devices. In another embodiment, each wireless device “knows” its trajectory from its autonomous vehicle control system, and can relay this information to the other wireless device or a central processor.

FIG. 1 depicts a third object in the environment, labeled Obstacle. This may be, for example, a robot, another vehicle such as a fork lift, or the like. The obstacle is also mobile, and its route is predicted as down and to the left, as depicted in FIG. 1. Because both the first and second wireless devices are moving generally up the page, and the obstacle is moving generally down, a blockage event is predicted at the location indicated, whereby the obstacle will physically block the ongoing mmWave communication link between the first and second wireless devices. In particular, based on the three objects' motion, speed, and predicted trajectories, a start time of the blockage event is estimated. An end time may also be estimated. In one embodiment the blockage event is predicted by a central processor monitoring the environment. In another embodiment one or both of the first and second wireless devices predicts the blockage event. In either case, the details of the blockage event comprise a small data set, which can be transmitted to the relevant entity. In one embodiment the blockage event is re-estimated periodically, as acceleration or a change in direction of any of the moving objects may alter the blockage event estimate.

In response to the blockage event prediction, actual blockage of the mmWave communication link is avoided by routing the link around the obstacle via a passive reflector. Depending on the time remaining until the estimated start time of the blockage event, the link redirection may occur in one of two ways.

In one embodiment, where insufficient time remains to re-train the beams, the current directional beams are “tilted” to the passive reflector. That is, the first, second, or both wireless devices control their antenna arrays so as to change their directional antenna beam's angle, azimuth, and elevation to point to the passive reflector rather than the other wireless device. The direction to the passive reflector is calculated based on the position of each wireless device, the position of the passive reflector, and the reflection angle, which may depend on the geometric shape of the passive reflector. A passive reflector provides significant gain, compared to a NLOS channel. In one embodiment, the passive reflector is commanded to tilt or rotate so as to provide the desired reflection angle. The beams are tilted just prior to the estimated start time of the blockage event. This results in a new path for the mmWave communication link, indicated in FIG. 1 by dashed lines labeled “Beam After Blockage.” The tilted directional antenna beams at the first and second wireless devices, indicated by dashed lines, both point to the passive reflector. Because only the directions of the directional beams were changed, the mmWave communication link is otherwise the same—i.e., at the same frequency, modulation scheme, frame structure, and the like.

In another embodiment, where the estimated blockage event start time is sufficiently distant, a group of beam pairs, directed toward the passive reflector, is selected and trained, using known directional antenna beam training algorithms. The selected beams are those not currently in use, and/or the beam pair currently engaging in the mmWave communication link. In one embodiment, the passive reflector is commanded to tilt or rotate along with the beam re-training, which changes the gain of the passive reflector(s). The beam pairs are then sorted by a channel quality metric, such as SINR. Beam re-training can be performed at any time after a blockage event is predicted. In one embodiment, beam re-training is performed as close as practicable to the estimated start time of the blockage event, as changes in the environment may render an earlier re-training suboptimal. In one embodiment, the number of re-trained beam pairs depends on the required reliability or data rate of the mmWave communication link. In one embodiment, after re-training, resources such as beam pairs, passive reflectors, operating frequencies, and the like are reserved to reestablish the pre-blockage mmWave communication link.

In one embodiment, the beams are re-trained at a different frequency than that used in the mmWave communication link subject to link blockage. This may reduce interference with other communication links. Additionally, a passive reflector may be used for more than one link blockage avoidance, as directional antenna beams at different frequencies do not interfere substantially.

Whether the current directional antenna beams are tilted to the passive reflector or re-trained to select an optimal beam pair (possibly at a different frequency), the beams are tilted or switched prior to the estimated start time of the blockage event, routing the mmWave communication link around the obstacle via one or more passive reflectors, as shown in FIG. 1 by dashed lines. In this manner, blockage of the mmWave communication link is avoided, and no data loss occurs between the first and second wireless devices. The alternate mmWave communication link is maintained throughout the blockage event. During this time, the motions of the wireless devices and/or obstacle are continuously monitored, and the directional antenna beams are adjusted as necessary keep them pointed towards the passive reflector. In one embodiment, the passive reflector is tilted or rotated as necessary to maintain the proper reflection angle.

After the blockage event—either after expiration of the estimated end time of the blockage event, or as indicated by ongoing/updated motion analysis of the environment—the beams are tilted or re-trained to remove the passive reflector from the link path, which is no longer required to route the link around an obstacle. For example, the first and second wireless devices may point their directional antenna beams directly at each other. Alternatively, they may utilize one or more passive reflectors to establish a path.

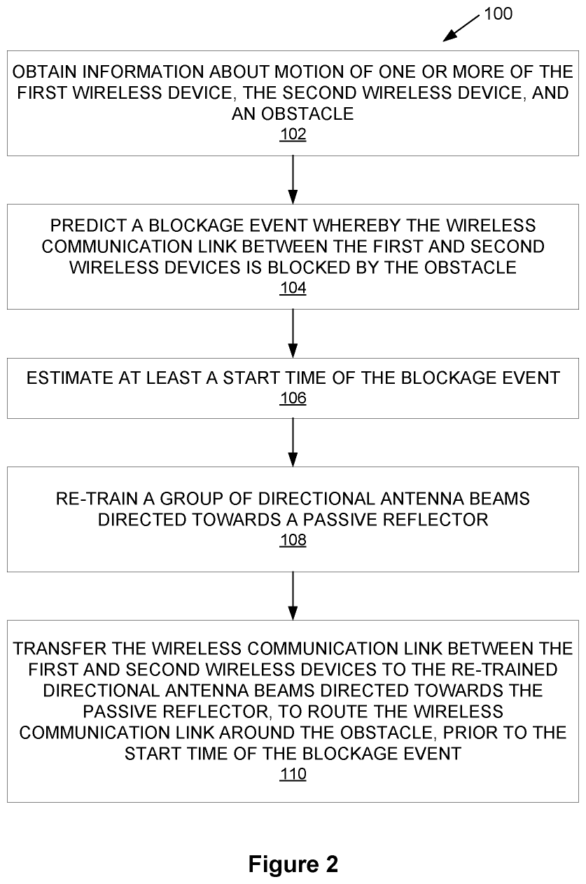

FIG. 2 depicts a method 100 in accordance with particular embodiments. The method 100 is a method of avoiding blockage of a wireless communication link between first and second wireless devices, each using directional antenna beams. Information about motion of one or more of the first wireless device, the second wireless device, and an obstacle is obtained (block 102). A blockage event, whereby the wireless communication link between the first and second wireless devices is blocked by the obstacle, is predicted (block 104). At least a start time of the blockage event is estimated (block 106). A group of directional antenna beams directed towards a passive reflector is re-trained (block 108). The wireless communication link between the first and second wireless devices is transferred to the re-trained directional antenna beams directed towards the passive reflector, to route the wireless communication link around the obstacle, prior to the start time of the blockage event (block 110).

In one embodiment, the method 100 is performed by a central processor monitoring the environment and performing link blockage avoidance for a plurality of mmWave communication links. In this embodiment, obtaining information about motion of one or more of the first wireless devices, the second wireless devices, and an obstacle comprises receiving the information from an imaging device, such as a visible light camera, an infrared camera, RADAR, LiDAR, or the like. The information may comprise the image data, and the central processor performs object detection, classification, and motion tracking on objects in the environment. Alternatively, one or more imaging devices may perform the object detection, classification, and motion tracking locally, and transmit only pertinent information to the central processor, such as object identification, size, speed, and trajectory. In this embodiment, the central processor predicts a blockage event for at least one mmWave communication link, and estimates a start time. The central processor re-trains a group of directional antenna beam pairs by sending commands to the first and second wireless devices to engage in a beam training process and report the results, as well known in the art. Based on the results received, the central processor selects a directional antenna beam pair. The central processor transfers the wireless communication link to the re-trained beams by sending commands to the first and second wireless devices.

In another embodiment, the method 100 is performed by the first wireless device. In this embodiment, obtaining information about motion of the second wireless devices and an obstacle comprises receiving the information from an imaging device or from a central processor. Obtaining information about motion of the first wireless devices comprises accessing positioning technology (e.g., reading an IMU sensor), and/or obtaining motion information from an autonomous vehicle control system associated with the first wireless device. In this embodiment, the first wireless device predicts a blockage event for its own mmWave communication link, and estimates a start time. The first wireless device re-trains a group of directional antenna beam pairs by sending and receiving reference signals, as well known in the art. The first wireless device transfers its end of the wireless communication link to the re-trained directional antenna beams directed towards a passive reflector by controlling a linear or planar antenna element array, as known in the art.

Apparatuses, such as a central processor or the first wireless device, may perform the method 100 described herein, and any other processing, by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

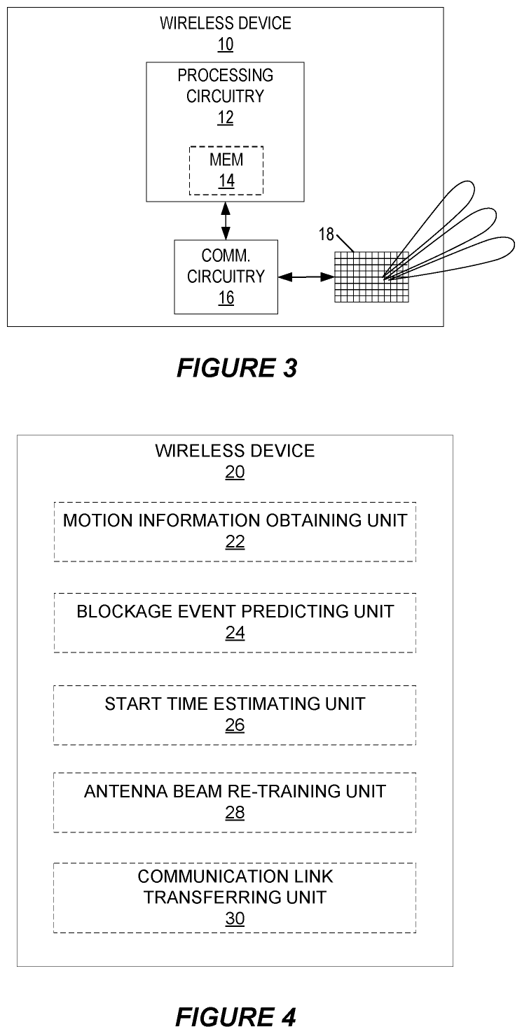

FIG. 3 for example illustrates a hardware block diagram of a wireless device 10 as implemented in accordance with one or more embodiments. As shown, the wireless device 10 includes processing circuitry 12 and communication circuitry 16. The communication circuitry 16 (e.g., radio circuitry) is configured to transmit and/or receive information to and/or from one or more other devices, e.g., via any communication technology. In particular, such communication may occur in directional antenna beams formed and controlled by a linear or planar antenna element array 18. The processing circuitry 12 is configured to perform processing described above, such as by executing instructions stored in memory 14. The processing circuitry 12 in this regard may implement certain functional means, units, or modules.

FIG. 4 illustrates a functional block diagram of a wireless device 20 according to still other embodiments. As shown, the wireless device 20 implements various functional means, units, or modules, e.g., via the processing circuitry 12 in FIG. 3 and/or via software code. These functional means, units, or modules, e.g., for implementing the method(s) herein, include for instance: motion information obtaining unit 22, blockage event predicting unit 24, start time estimating unit 26, antenna beam re-training unit 28, and communication link transferring unit Motion information obtaining unit 22 is configured to obtain information about motion of one or more of the first wireless device, the second wireless device, and an obstacle. Blockage event predicting unit 24 is configured to predict a blockage event whereby the wireless communication link between the first and second wireless devices is blocked by the obstacle. Start time estimating unit 26 is configured to estimate at least a start time of the blockage event. Antenna beam re-training unit 28 is configured to re-train a group of directional antenna beams directed towards the passive reflector. Communication link transferring unit 30 is configured to transfer the wireless communication link between the first and second wireless devices to the re-trained directional antenna beams directed towards the passive reflector, to route the wireless communication link around the obstacle, prior to the start time of the blockage event.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Embodiments of the present invention present numerous advantages over the prior art. By using obstacle detection and motion tracking via imaging devices, mmWave communication link blockages are predicted. Using passive reflectors, a mmWave communication link is dynamically re-routed around the obstacle prior to the start of the blockage. This results in reliable, seamless communication among mobile devices. Directional antenna beam re-training, along with a fixed or variable configuration of the passive reflectors, yields an optimal transmit/receive directional antenna beam pair for the duration of the blockage. In contrast to the prior art, the system re-routes the communication link before the link blockage occurs. Because beam re-training is performed before the link blockage, it is possible to reserve resources such as beam pairs, passive reflectors, and frequency bands to re-route the communication link during the link blockage event for seamless communication, which is critical in URLLC use cases. Importantly, the solution scales up with the number of moving objects, i.e., potential obstacles, since number of objects in an image does not increase the complexity of object detection or motion tracking algorithms. Additionally, because many environments, such as factories, are equipped with surveillance cameras, embodiments of the present invention can be implemented without incurring significant costs.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein. As used herein, the term “configured to” means set up, organized, adapted, or arranged to operate in a particular way; the term is synonymous with “designed to.”

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1-30. (canceled)

31. A method of avoiding blockage of a wireless communication link between first and second wireless devices, each using directional antenna beams, characterized by:
obtaining information about motion of one or more of the first wireless device, the second wireless device, and an obstacle;
predicting a blockage event whereby the wireless communication link between the first and second wireless devices is blocked by the obstacle;
estimating at least a start time of the blockage event;
re-training a group of directional antenna beams directed towards a passive reflector; and
transferring the wireless communication link between the first and second wireless devices to the re-trained directional antenna beams directed towards the passive reflector, to route the wireless communication link around the obstacle, prior to the start time of the blockage event.

32. The method of claim 31 further comprising, after estimating a start time of the blockage event and prior to re-training the group of directional antenna beams:
determining whether sufficient time is available for beam re-training;
wherein re-training a group of directional antenna beams directed towards a passive reflector comprises re-training the group of directional antenna beams only if it is determined that sufficient time is available for beam retraining.

33. The method of claim 31 wherein re-training a group of directional antenna beams comprises:
selecting a group of directional antenna beam pairs directed toward the passive reflector;
transmitting or receiving reference signals for each directional antenna beam pair in the group;
evaluating one or more metrics of wireless communication link quality for each of the directional antenna beam pairs; and
selecting a directional antenna beam pair based on the one or more metrics of wireless communication link quality.

34. The method of claim 33 wherein a metric of wireless communication link quality is Signal to Interference plus Noise Ratio (SINR).

35. The method of claim 31 wherein re-training a group of directional antenna beams directed towards the passive reflector comprises:
repositioning the passive reflector to establish two or more reflection angles; and
re-training the group of directional antenna beam pairs for each of the two or more reflection angles.

36. The method of claim 31 wherein re-training the group of directional antenna beam comprises re-training the group of directional antenna beams at one or more frequencies different than a frequency used on the communication link prior to the blockage event.

37. The method of claim 31 further comprising, if it is determined that insufficient time is available for beam re-training, tilting the directional antenna beams towards the passive reflector.

38. The method of claim 31 wherein the wireless communication link is a mmWave wireless communication link.

39. The method of claim 31 wherein the steps of obtaining information, predicting a blockage event, and estimating a start time are performed by a central processor and the steps of re-training a group of directional antenna beams and transferring the wireless communication link to the re-trained directional antenna beams are performed by the first wireless device, and further characterized by:
transferring information about the predicted blockage event and estimated start time from the central processor to the wireless device in advance of the estimated start time.

40. A first wireless device configured to generate directional antenna beams for a wireless communication link with a second wireless device, characterized by:
communication circuitry comprising a linear or planar antenna element array; and
processing circuitry operatively connected to the communication circuitry, the processing circuitry configured to
obtain information about motion of one or more of the first wireless device, the second wireless device, and an obstacle;
predict a blockage event whereby the wireless communication link between the first and second wireless devices is blocked by the obstacle;
estimate at least a start time of the blockage event; and
re-train a group of directional antenna beams directed towards the passive reflector; and
transfer the wireless communication link between the first and second wireless devices to the re-trained directional antenna beams directed towards the passive reflector, to route the wireless communication link around the obstacle, prior to the start time of the blockage event.

41. The first wireless device of claim 40 wherein the processing circuitry is further configured to, after estimating a start time of the blockage event and prior to re-training the group of directional antenna beams:
determine whether sufficient time is available for beam re-training; and
wherein the processing circuitry is configured to re-train a group of directional antenna beams directed towards a passive reflector by re-training the group of directional antenna beams only if it is determined that sufficient time is available for beam retraining.

42. The first wireless device of claim 40 wherein the processing circuitry is configured to re-train a group of directional antenna beams by:
selecting a group of directional antenna beam pairs directed toward a passive reflector;
transmitting or receiving reference signals for each directional antenna beam pair in the group;
evaluating one or more metrics of wireless communication link quality for each of the directional antenna beam pairs; and
selecting a directional antenna beam pair based on the one or more metrics of wireless communication link quality.

43. The first wireless device of claim 40 wherein a metric of wireless communication link quality is Signal to Interference plus Noise (SINR).

44. The first wireless device of claim 40 wherein the passive reflector is repositioned to establish two or more reflection angles, and wherein the processing circuitry is further configured to:
re-train the group of directional antenna beam pairs for each of the two or more reflection angles.

45. The first wireless device of claim 40 wherein the processing circuitry is configured to re-train the group of directional antenna beam by re-training the group of directional antenna beams at one or more frequencies different than a frequency used on the wireless communication link prior to the blockage event.

46. The first wireless device of claim 40 wherein the wireless communication link is a mmWave wireless communication link.

47. The first wireless device of claim 40 wherein the processing circuitry is further configured to, after estimating a start time of the blockage event and prior to re-training the group of directional antenna beams:
determine whether sufficient time is available for beam re-training; and
wherein the processing circuitry is configured to tilt the directional antenna beams towards the passive reflector if it is determined that insufficient time is available for beam re-training.
